(19) United States
(12) Patent Application Publication
(10) Pub. No.: US 2015/0324436 A1
(43) Pub. Date: Nov. 12, 2015

(54) DATA PROCESSING SYSTEM AND DATA PROCESSING METHOD

(71) Applicant: HITACHI, LTD., Chiyoda-ku, Tokyo (JP)

(72) Inventors: Yusuke FUJITA, Tokyo (JP); Nobuo NUKAGA, Tokyo (JP); Shoji KODAMA, Tokyo (JP)

(21) Appl. No.: 14/649,762

(22) PCT Filed: Dec. 28, 2012
(86) PCT No.: PCT/JP2012/084007

§ 371 Date: Jun. 4, 2015

(51) Int. Cl. G06F 17/30; G06F 7/24

(52) U.S. Cl. CPC G06F 17/30563; G06F 7/24; G06F 17/30595

(57) ABSTRACT

A data processing system holds metadata extraction dictionary information defining a condition for extracting metadata from a plurality of kinds of data and relevance dictionary information defining a condition for associating the metadata extracted from the plurality of kinds of data, extracts the metadata from the plurality of kinds of data on the basis of the metadata extraction dictionary information, extracts metadata from inputted data, associates the metadata extracted from the inputted data with the metadata extracted from the plurality of kinds of data on the basis of the relevance dictionary information, and outputs information indicating a relation of any combination of the plurality of kinds of data, the inputted data, and the metadata extracted from the plurality of kinds of data and the inputted data on the basis of a result of the association.

### TECHNICAL FIELD

The present invention relates to extraction of data from a plurality of modalities and a processing technology of the data.

### BACKGROUND ART

As a background art in this technical field, United States patent application publication No. 2010/0185934, specification (PTL 1) is disclosed. The specification describes that “Methods, systems, and device, including computer programs stored on computer storage media, for retrieval and display of information from an electronic document collection. One aspect can be embodied in machine-implemented methods that include the actions of receiving description data describing a preexisting structured presentation, comparing characteristics of the preexisting structured presentation with content of electronic documents in an unstructured collection of electronic documents to locate electronic documents that identify a new attribute that is relevant to the preexisting structured presentation, adding an identifier of the new attribute to the preexisting structured presentation to form an expanded structured presentation, and outputting instructions for presenting the expanded structured presentation.” (see ABSTRACT).

### CITATION LIST

### Patent Literature

PTL 1: United States patent application publication No. 2010/0185934, specification

### SUMMARY OF INVENTION

### Technical Problem

Conventionally, data mining for predicting occurrence of an event with the use of data is performed based on structured data arranged in the form of a table or a relational database. However, data that can be fetched as the structured data is only data to which an attribute name and an attribute value have been applied for specific use in advance in a computer system, and the data mining cannot be directly performed on unstructured data such as an image, sound, and an atypical document.

Meanwhile, a full-text search engine for text documents can search a term in unstructured data at a high speed, and therefore it is possible to perform simple conditional search with the use of a term list. Further, a plurality of pieces of structured data can be linked on the basis of a rule, and therefore it is possible to generate large structured data by searching structured data from a large amount of data on the Internet. Further, it is possible to acquire a partial structure by performing syntax analysis of text on unstructured data. For example, PTL 1 discloses a method of adding an attribute name and an attribute value of a table by combining those technologies.

However, data mining of unstructured data linked to structured data and search of unstructured data using not only a term list but also an attribute condition thereof have not been achieved. Even in a case where a structure can be partially given to unstructured data, there is no conventional method for determining to which row or column in structured data the structure is linked.

The invention has been made in view of the above points, and an object of the invention is to provide a data extraction and processing method for performing data mining and conditional search with the use of data extracted from a plurality of modalities.

### Solution to Problem

In order to solve the above problems, the invention is a data processing system including: one or more processors; and one or more storage devices connected to the one or more processors, and the data processing system holds metadata extraction dictionary information defining a condition for extracting metadata from a plurality of kinds of data and relevance dictionary information defining a condition for associating the metadata extracted from the plurality of kinds of data, extracts the metadata from the plurality of kinds of data on the basis of the metadata extraction dictionary information, extracts metadata from inputted data, associates the metadata extracted from the inputted data with the metadata extracted from the plurality of kinds of data on the basis of the relevance dictionary information, and outputs information indicating a relation of any combination of the plurality of kinds of data, the inputted data, and the metadata extracted from the plurality of kinds of data and the inputted data on the basis of a result of the association.

### Advantageous Effects of Invention

According to an embodiment of the invention, metadata related to input data can be easily searched and processed.

Problems, configurations, and effects other than the above ones will be disclosed by the following description of the embodiment.

### BRIEF DESCRIPTION OF DRAWINGS

FIG. 1 is a block diagram showing a whole configuration of a data processing system in Example 1 of the invention.

FIG. 2 is a block diagram showing a hardware configuration of a data processing system in Example 1 of the invention.

FIG. 3 is a flowchart showing operation of metadata database construction processing in Example 1 of the invention.

FIG. 4 shows details of processing in which an image metadata extraction unit extracts metadata of image data in Example 1 of the invention.

FIG. 5 shows details of processing in which a document metadata extraction unit extracts metadata of document data in Example 1 of the invention.

FIG. 6 shows details of processing in which a metadata association unit performs association on metadata in Example 1 of the invention.

FIG. 7 is a flowchart showing operation of data processing in Example 1 of the invention.

FIG. 8 shows details of processing in which an input data association unit extracts an attribute relationship from a received table in Example 1 of the invention.

FIG. 9 shows details of processing in which an input data association unit performs association on table structure attribute information in Example 1 of the invention.

FIG. 10 shows processing in which a data processing unit adds an attribute to input data in Example 1 of the invention.

FIG. 11 is a block diagram showing a whole configuration of a data processing system in Example 2 of the invention.

FIG. 12 shows details of processing in which a sound metadata extraction unit extracts metadata of sound data in Example 2 of the invention.

FIG. 13 shows details of processing in which a text metadata extraction unit extracts metadata of text data in Example 2 of the invention.

FIG. 14 is a flowchart showing operation of data processing in Example 2 of the invention.

FIG. 15 shows details of processing in which an input data association unit performs association on an extracted keyword in Example 2 of the invention.

FIG. 16 shows processing in which a data processing unit associates sound metadata with text metadata in Example 2 of the invention.

### DESCRIPTION OF EMBODIMENTS

Hereinafter, examples will be described with reference to drawings.

### EXAMPLE 1

This example will describe an example of a data processing system for expanding an inputted table on the basis of a metadata database regarding image data and document data constructed in advance. This system can be used, for example, to manage a design drawing and a design document issued when a building, a machine, or the like is produced. When a table regarding design is inputted, the table is automatically expanded with the use of metadata extracted from a design drawing and a design document. In this way, it is possible to obtain a large table regarding design, and therefore this example is applicable to data mining such as defect analysis, failure prediction, or the like of design.

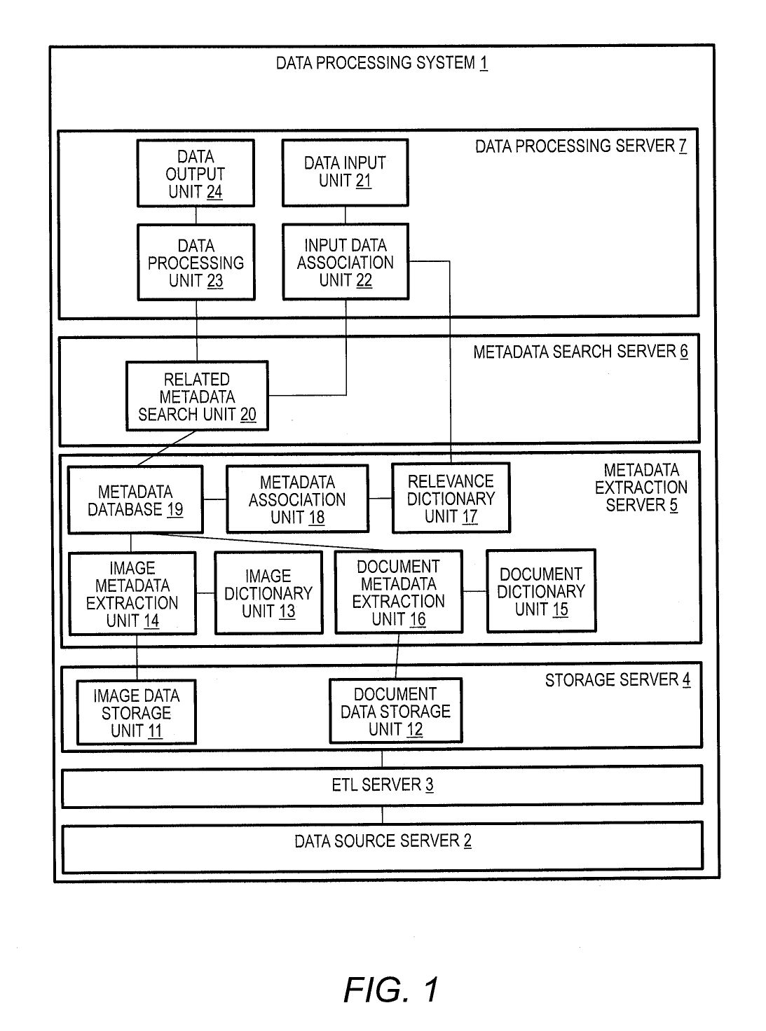

FIG. 1 is a block diagram showing a whole configuration of a data processing system in Example 1 of the invention.

A data processing system 1 includes a data source server 2, an ETL (Extract Transform Load) server 3, a storage server 4, a metadata extraction server 5, a metadata search server 6, and a data processing server 7.

The data source server 2 is a device for managing an image and a document. The data source server 2 includes a relational database (not shown) for managing a drawing by linking the drawing to an ID (identification information) and a file server (not shown) for storing a text document.

The ETL server 3 has a function of storing, in the storage server 4, image data and document data stored in the data source server 2. Herein, conversion such as unification of formats of the image and the document is performed.

The storage server 4 includes an image data storage unit 11 and a document data storage unit 12 and stores, in a unified format, image data and document data collected from a plurality of data sources.

The metadata extraction server 5 includes an image dictionary unit 13, an image metadata extraction unit 14, a document dictionary unit 15, a document metadata extraction unit 16, a relevance dictionary unit 17, a metadata association unit 18, and a metadata database 19 and manages metadata extracted from the data stored in the storage server 4.

The metadata search server 6 includes a related metadata search unit 20 and receives a search request to return a result of search of the metadata database 19.

The data processing server 7 includes a data input unit 21, an input data association unit 22, a data processing unit 23, and a data output unit 24 and processes inputted data on the basis of metadata to output the processed data.

Each unit will be described in detail below.

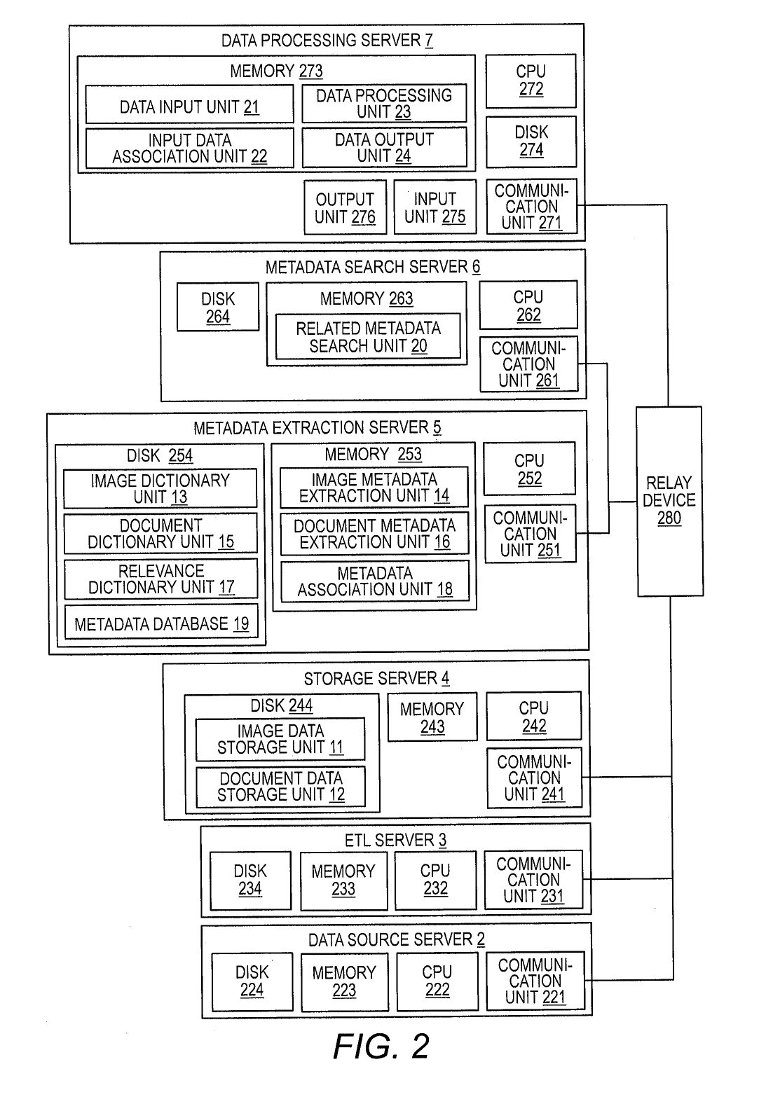

FIG. 2 is a block diagram showing a hardware configuration of the data processing system 1 in Example 1 of the invention.

The data source server 2 is a computer including a communication unit 221, a CPU (Central Processing Unit) 222, a memory 223, and a disk 224 that are connected to one another.

The communication unit 221 is connected to a relay device 280 and is an interface for communicating with other servers via the relay device 280. The CPU 222 is a processor for executing a program stored in the memory 223 to thereby achieve a predetermined function. The memory 223 and the disk 224 are storage devices for storing the program executed by the CPU 222, data referred to by the CPU 222, and the like. Those may be any kind of storage devices. However, as typical examples, the memory 223 is a relatively high speed semiconductor memory such as a DRAM (Dynamic Random Access Memory) and the disk 224 is a relatively large capacity storage device such as a hard disk device.

The ETL server 3 is a computer including a communication unit 231, a CPU 232, a memory 233, and a disk 234 that are connected to one another. Description of those units is omitted because the description thereof is similar to the description of the communication unit 221, the CPU 222, the memory 223, and the disk 224 of the data source server 2.

The storage server 4 is a computer including a communication unit 241, a CPU 242, a memory 243, and a disk 244 that are connected to one another. Description of those units is omitted because the description thereof is similar to the description of the communication unit 221, the CPU 222, the memory 223, and the disk 224 of the data source server 2. However, the disk 244 includes the image data storage unit 11 for storing image data and the document data storage unit 12 for storing document data. A part or all of data stored in the image data storage unit 11 and the document data storage unit 12 may be copied to the memory 243 as necessary.

The metadata extraction server 5 is a computer including a communication unit 251, a CPU 252, a memory 253, and a disk 254 that are connected to one another. Description of those units is omitted because the description thereof is similar to the description of the communication unit 221, the CPU 222, the memory 223, and the disk 224 of the data source server 2. However, the memory 253 includes the image metadata extraction unit 14, the document metadata extraction unit 16, and the metadata association unit 18. Those are programs executed by the CPU 252.

In the following description, processing executed by the image metadata extraction unit 14, the document metadata extraction unit 16, or the metadata association unit 18 will be described. Such processing is processing actually executed by the CPU 252 controlling the memory 253, the disk 254, the communication unit 251, and the like in accordance with the above programs as necessary. Processing executed by programs stored in a memory 263 and a memory 273 described below is also executed actually by CPUs of respective computers in the same way as described above.

Note that the image metadata extraction unit 14, the document metadata extraction unit 16, and the metadata association unit 18 are stored in the disk 254 and may be copied to the memory 253 as necessary. The same applies to the programs stored in the memory 263 and the memory 273 described below.

The metadata search server 6 is a computer including a communication unit 261, a CPU 262, a memory 263, and a disk 264 that are connected to one another. Description of those units is omitted because the description thereof is similar to the description of the communication unit 221, the CPU 222, the memory 223, and the disk 224 of the data source server 2. However, the memory 263 includes the related metadata search unit 20. This is a program executed by the CPU 262.

The data processing server 7 is a computer including a communication unit 271, a CPU 272, a memory 273, and a disk 274 that are connected to one another. Description of those units is omitted because the description thereof is similar to the description of the communication unit 221, the CPU 222, the memory 223, and the disk 224 of the data source server 2. However, the memory 273 includes the data input unit 21, the input data association unit 22, the data processing unit 23, and the data output unit 24. Those are programs executed by the CPU 272.

The data processing server 7 further includes an input unit 275 and an output unit 276 that are connected to the CPU 272 and are controlled by the data input unit 21 and the data output unit 24. The input unit 275 is, for example, an input device such as a keyboard and a pointing device, and the output unit 276 is, for example, an output device such as an image display device.

Although not shown in FIG. 2, each of the servers configuring the data processing system 1 other than the data processing server 7 may also include an input unit and an output unit similar to those of the data processing server 7.

The relay device 280 is connected to the communication units of the respective servers and is a device for relaying communication between the servers.

FIG. 2 shows an example of the hardware configuration in which each server is realized by an independent computer including a single CPU and one or more storage devices. However, the above hardware configuration is merely an example, and this example can be actually achieved by various computer systems including at least one CPU and one or more storage devices. For example, the data processing system 1 may be realized by a storage device storing all the above programs and data and a single computer including at least one CPU. Alternatively, for example, the data source server 2 maybe realized by a single computer, the ETL server 3 and the storage server 4 may be realized by another single computer, the metadata extraction server 5, the metadata search server 6, and the data processing server 7 may be realized by still another single computer. In such a case, each server may be a virtual server generated by using a virtualization technology.

Operation of the data processing system 1 configured as described above according to this example will be described. The operation of the system is divided into metadata database construction processing and data processing.

Operation of the metadata database construction processing will be described.

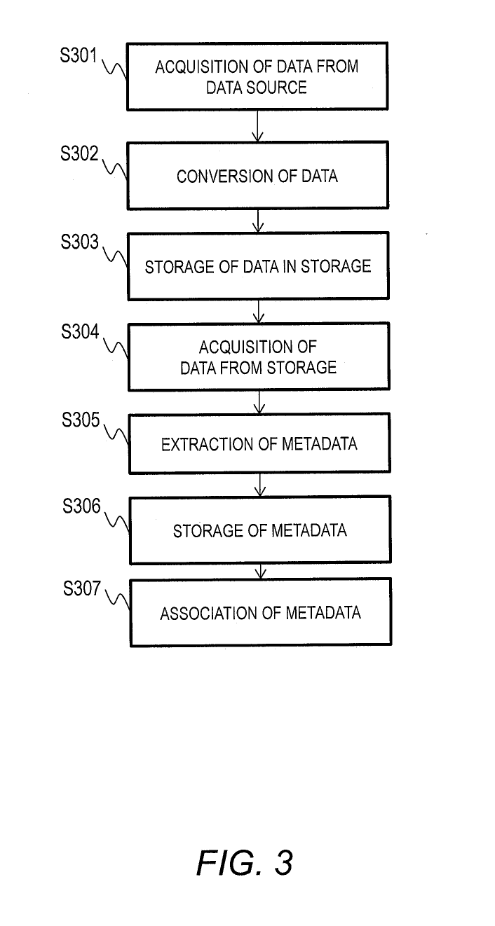

FIG. 3 is a flowchart showing the operation of the metadata database construction processing in Example 1 of the invention.

The ETL server 3 acquires image data and document data from the data source server 2 (Step S301). Then, the ETL server 3 performs necessary conversion on the image data and the document data (Step S302). For example, in a case where the image metadata extraction unit 14 described below only receives image data having a certain format, processing for converting a format of image data into the certain format is performed. Subsequently, the ETL server 3 stores the converted image data and the converted document data in the image data storage unit 11 and the document data storage unit 12, respectively, of the storage server 4 (Step S303).

Thereafter, the metadata extraction server 5 acquires the image data and the document data from the storage server 4 (Step S304).

Then, the image metadata extraction unit 14 of the metadata extraction server 5 extracts metadata of the image data on the basis of the image dictionary unit 13 (Step S305).

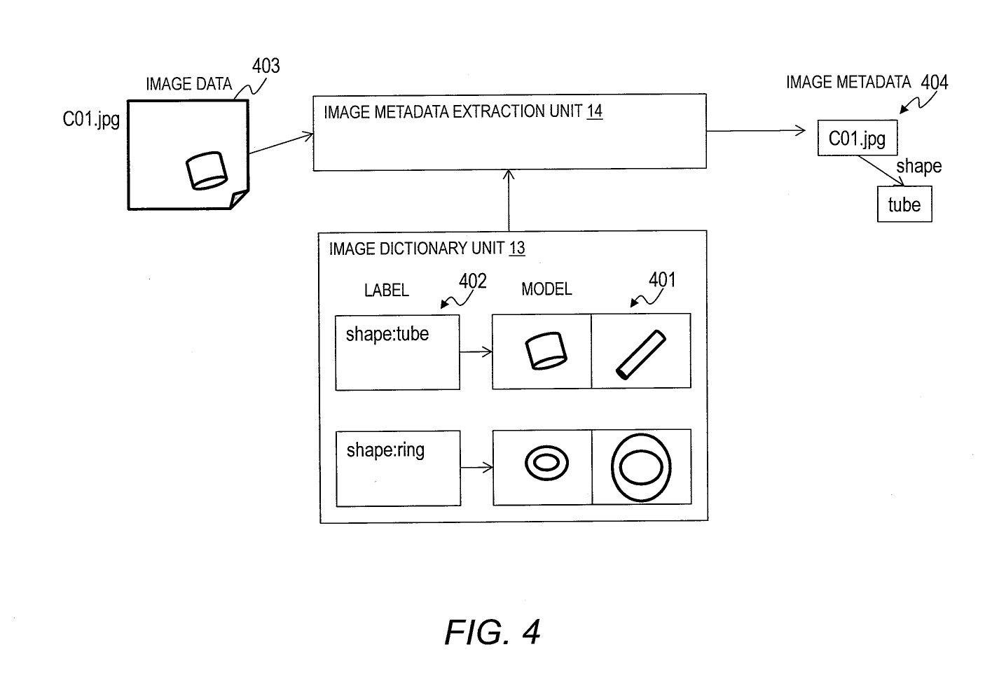

FIG. 4 shows details of the processing (Step S305 in FIG. 3) in which the image metadata extraction unit 14 extracts the metadata of the image data in Example 1 of the invention.

The image dictionary unit 13 holds models 401 used for performing recognition and classification on the basis of shapes, color information, and the like of images. The models 401 are associated with labels 402, respectively. For example, the model 401 corresponding to an image of a figure of a tube is associated with “shape:tube” serving as the label 402. By using an image recognition technology based on the image dictionary unit 13, the image metadata extraction unit 14 applies the label 402 to image data 403 acquired from the image data storage unit 11. Specifically, for example, the image metadata extraction unit 14 may compare similarity between the image data 403 and each model 401 by using a publicly-known image recognition technology and apply, to the image data 403, the label 402 associated with the model 401 having the highest similarity. In the example of FIG. 4, the image metadata extraction unit 14 applies the label of “shape:tube” to the image data 403 and outputs a result thereof as image metadata 404.

The image metadata 404 is an expression indicating “shape of C01.jpg is tube” and can be described for an expression of a ternary relation such as “B of A is C” with the use of, for example, RDF (Resource Description Framework).

Further, in Step S305, the document metadata extraction unit 16 extracts metadata of the document data on the basis of the document dictionary unit 15.

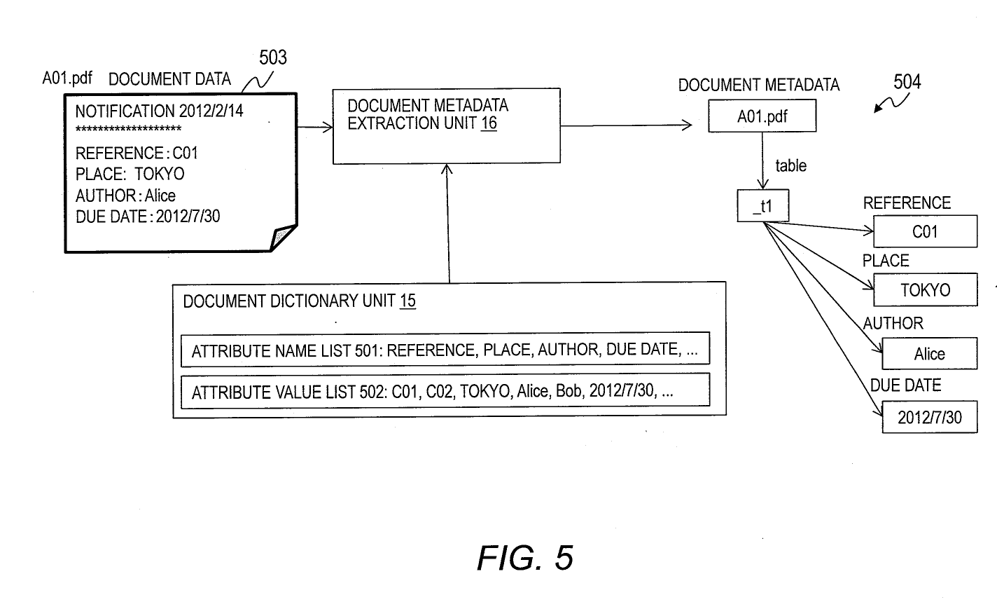

FIG. 5 shows details of the processing (Step S305) in which the document metadata extraction unit 16 extracts the metadata of the document data in Example 1 of the invention.

The document dictionary unit 15 holds an attribute name list 501 including terms suitable as attribute names and an attribute value list 502 including terms suitable as attribute values with respect to terms in a document. The document metadata extraction unit 16 analyzes a structure of document data 503 acquired from the document data storage unit 12 on the basis of the document dictionary unit 15 and a result of analysis of layout of the document, thereby generating document metadata 504.

In the example of FIG. 5, the document data 503 includes character strings such as “notification:C01” and “place:Tokyo”. Meanwhile, the attribute name list 501 includes terms such as “reference”, “place”, and “author”, and the attribute value list 502 includes terms such as “C01”, “C02”, “Tokyo”, and “Alice”.

In this example, the document metadata extraction unit 16 extracts, from the document data 503, attribute names such as “reference” and “place” on the basis of the attribute name list 501 and attribute values such as “C01” and “Tokyo” on the basis of the attribute value list 502 and associates, for example, “reference” with “C01” and “place” with “Tokyo” on the basis of layout information in which those terms are arranged while having a colon therebetween, thereby generating the document metadata 504 as a result of structuring of a table. The document metadata 504 can be described with the use of the RDF in the same way as the image metadata 404.

Then, the image metadata extraction unit 14 and the document metadata extraction unit 16 store the extracted metadata in the metadata database 19 (Step S306). Herein, by using a database for managing the RDF, the image metadata and the document metadata can be managed in the same database.

Thereafter, the metadata association unit 18 performs association on the metadata stored in the metadata database 19 with the use of the relevance dictionary unit 17 (Step S307).

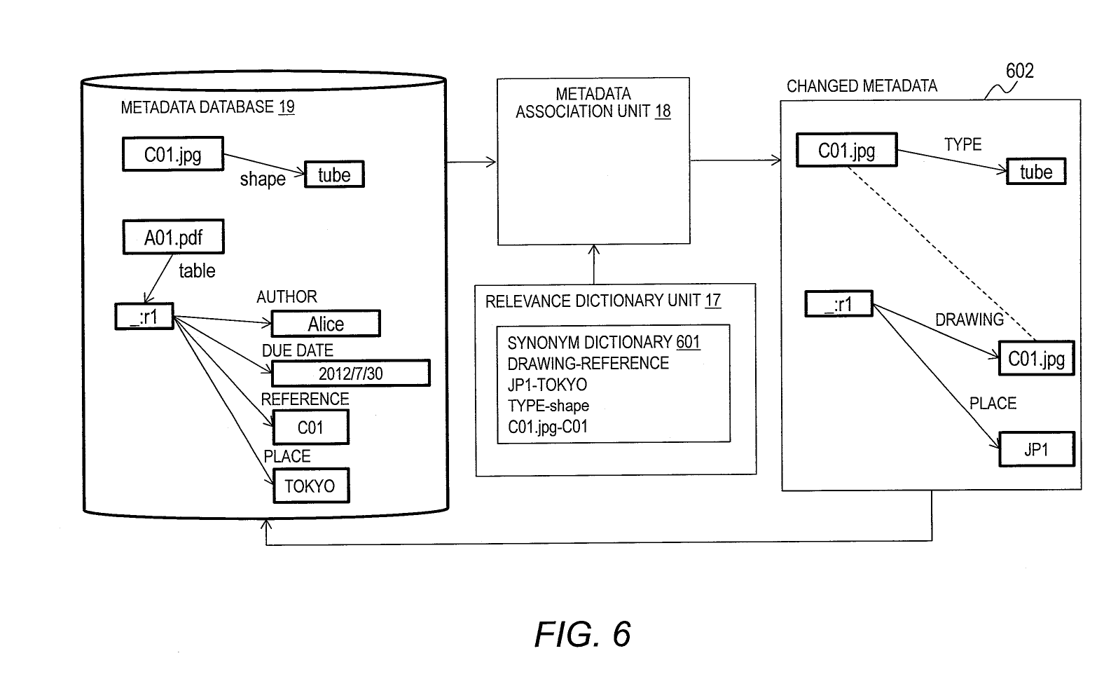

FIG. 6 shows details of the processing (Step S307) in which the metadata association unit 18 performs association on the metadata in Example 1 of the invention.

The relevance dictionary unit 17 holds a synonym dictionary 601, and, for example, “drawing” and “reference”, “type” and “shape”, and “C01” and “C01.jpg” are constructed as synonym relationships by a designer of the system in advance. The synonym dictionary 601 may be a dictionary having a synonymous relationship between terms in different languages on the basis of a translation dictionary that is additionally prepared.

Note that the synonym dictionary may be any dictionary as long as the synonym dictionary is information defining information replaceable with certain metadata. Specifically, the synonym dictionary is information indicating that information contained in metadata of a certain modality and information contained in metadata of another modality and synonymous therewith are replaceable and may be the synonym dictionary or the translation dictionary described above or may be, for example, a dictionary (see Example 2) defining a synonymous relationship between a spoken language and a written language.

The metadata association unit 18 searches a term existing in the synonym dictionary 601 from the metadata database 19, converts the term into changed metadata 602 in which the term is replaced with another term having a synonym relationship therewith, and updates the metadata database 19. In the example of FIG. 6, as to a term “shape” in the synonym dictionary 601, image metadata “shape of C01.jpg is tube” is searched. In this case, the metadata association unit 18 replaces “shape” with a “type” which is a synonym thereof on the basis of the synonym dictionary 601, thereby converting the searched image metadata into metadata “type of C01.jpg is tube”.

Similarly, “reference of _:r1 is C01” is converted into “drawing of _:r1 is C01.jpg”, and “place of _:r1 is Tokyo” is converted into “place of _:r1 is JP1”.

Herein, an example of updating searched metadata to new metadata has been described above. This is an example of a method for describing a term replaceable with a term of an attribute name or an attribute value included in searched metadata in accordance with a synonym relationship. In Step S307, for example, it is only necessary to describe that the term “shape” in the metadata database and the term “type” are replaceable and the term “C01” and the term “C01.jpg” are replaceable in accordance with the synonym relationship. Specifically, instead of rewriting the searched metadata “shape of C01.jpg is tube”, for example, the metadata association unit 18 may add, to the metadata, information indicating that the term “shape” and the term “type” are replaceable and information indicating that the term “C01” and the term “C01.jpg” are replaceable on the basis of the synonym dictionary 601.

Note that, in a case where searched metadata is updated to new metadata on the basis of the synonym dictionary as described above, it is necessary to update the metadata so that a single expression is given to metadata having a synonymous relationship. For example, in a case where certain metadata has the term “C01”, another metadata has the term “C01.jpg”, and still another metadata has another term synonymous therewith, it is necessary to convert all the terms synonymous with the term “C01.jpg” into the term “C01.jpg” that represents the terms. Any term may be used as a representative term, and, for example, a term on the top of a list of a plurality of terms having a synonymous relationship may be used.

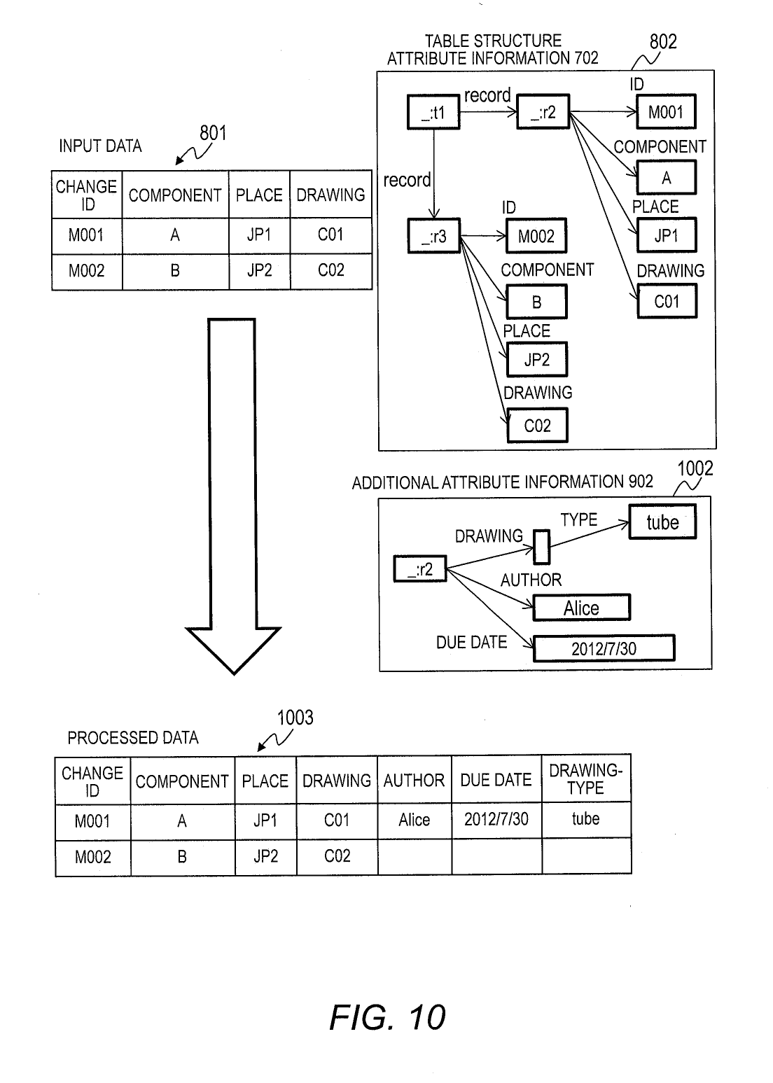

Herein, as indicated by a dotted line in FIG. 6, the image metadata and the document metadata are associated with each other via “C01.jpg”. That is, when “drawing of _:r1 is C01.jpg and type of C01.jpg is tube” is rephrased, “type of drawing of _:r1 is tube” is signified. In such a case, “drawing-type” obtained by combining two attribute names “drawing” and “type” associated via the attribute value “C01.jpg” may be treated as a new attribute name (see FIG. 10).

In this way, the metadata database 19 is constructed.

For example, in a case where pieces of metadata extracted from multiple modal data have the same (or a relevant) concept but different expressions are given to the pieces of the metadata of the respective modalities depending on characteristics of the modalities, those expressions are unified by update of the metadata described above, addition of replaceable metadata, or the like. This makes it possible to search all relevant metadata in processing described below.

Operation of the data processing will be described.

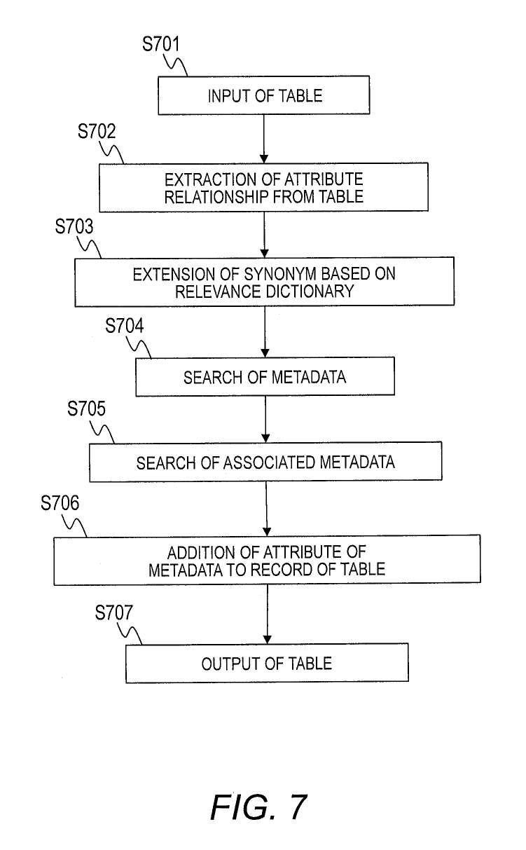

FIG. 7 is a flowchart showing the operation of the data processing in Example 1 of the invention.

The data input unit 21 receives input of table data from a user (Step S701). The table data inputted herein (e.g., input data 801 described below) is arbitrary structured data held in the data processing system 1 in advance (or, for example, acquired from outside of the data processing system 1 via the input unit 275 or the communication unit 271) and is associated with unstructured data by the following processing.

Then, the input data association unit 22 extracts an attribute relationship from the received table (Step S702).

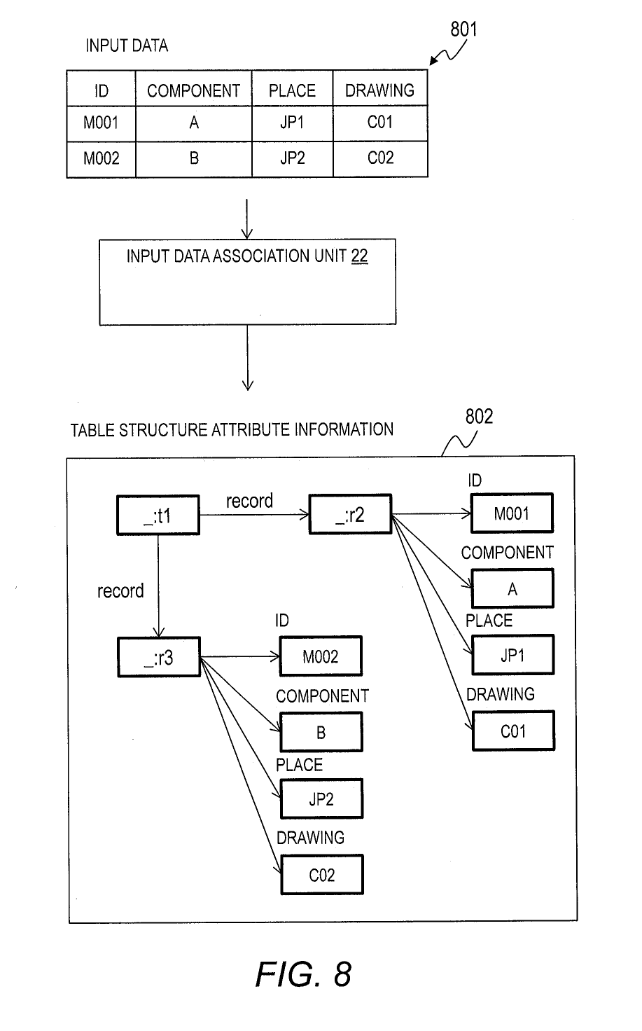

FIG. 8 shows details of the processing (Step S702) in which the input data association unit 22 extracts the attribute relationship from the received table in Example 1 of the invention.

The input data association unit 22 extracts information of a record and extracts a relationship between an attribute and an attribute name from the input data 801 and then outputs table structure attribute information 802. The table structure attribute information 802 can be described with the use of the RDF in the same way as the description of the image metadata and the document metadata.

For example, in a case where “M001”, “A”, “JP1”, and “C01” are included as values associated with items “ID”, “component”, “place”, and “drawing” in one record of the input data 801, the record is identified as “_:r2”, and the table structure attribute information 802 having description in the form of the RDF, such as “ID of _:r2 is M001”, “component of _:r2 is A”, “place of _:r2 is JP1”, and “drawing of _:r2 is C01”, is outputted.

Then, the input data association unit 22 performs association on the table structure attribute information 802 with the use of the relevance dictionary unit 17 (Step S703).

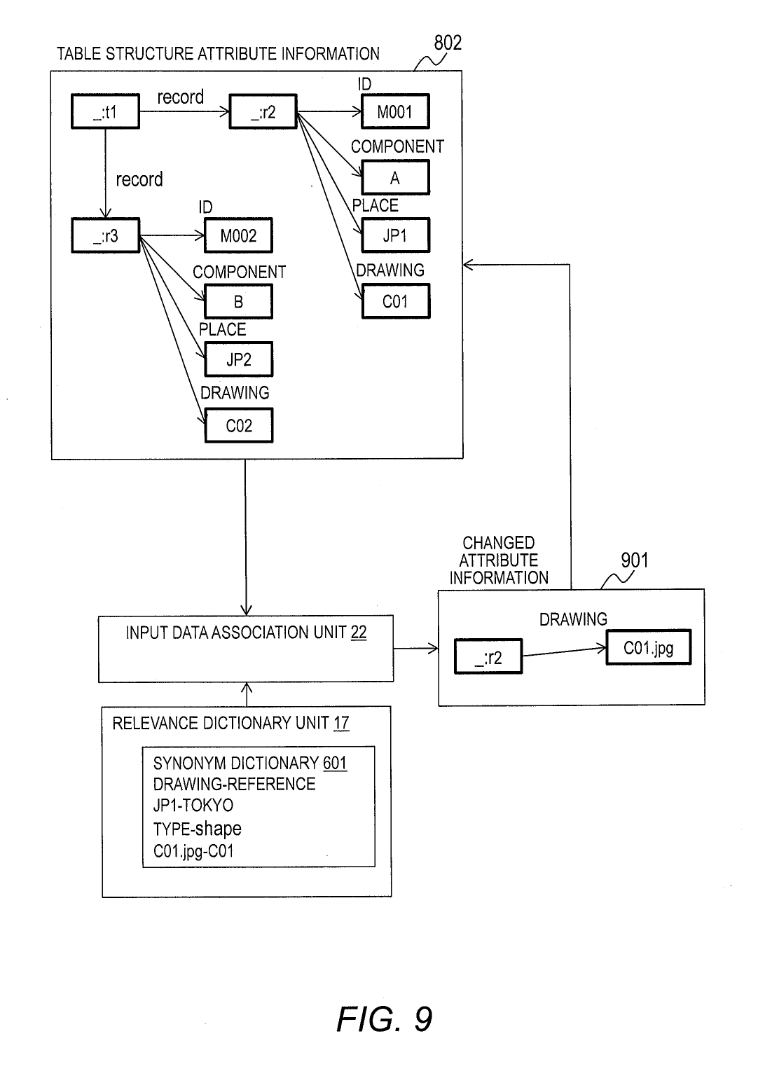

FIG. 9 shows details of the processing (Step S703) in which the input data association unit 22 performs association on the table structure attribute information 802 in Example 1 of the invention.

The input data association unit 22, as well as a function of the metadata association unit 18, searches a term existing in the synonym dictionary 601 from the table structure attribute information 802 and replaces the term with a term having a synonym relationship therewith. Thus, the input data association unit 22 generates changed attribute information 901 and changes the table structure attribute information 802 on the basis of the changed attribute information 901. In the example of FIG. 9, as to the term “C01” in the synonym dictionary 601, “drawing of _:r2 is C01” is searched from the table structure attribute information 802 and is changed to attribute information “drawing of _:r2 is C01.jpg” on the basis of the synonym relationship between “C01” and “C01.jpg”.

Note that, as with the association processing executed by the metadata association unit 18, the input data association unit 22 may add information indicating that “C01” and “C01.jpg” are replaceable to the table structure attribute information 802, instead of rewriting the table structure attribute information 802 to the changed attribute information 901.

Then, the related metadata search unit 20 searches the metadata database 19 with the use of the table structure attribute information 802 (Step S704). Herein, metadata having an attribute relationship that is the same as that of the input is selected as an inquiry to the metadata database 19. The metadata database 19 has information “drawing of _:r1 is C01.jpg” (see FIG. 6) with respect to “drawing of _:r2 is C01.jpg” existing in the table structure attribute information 802, and therefore it is possible to find the information as the information having the attribute relationship that is the same as that of the input. Similarly, it is also possible to find “place of _:r1 is Tokyo” with respect to “place of _:r2 is Tokyo”.

Herein, in a case where attribute relationships of a plurality of records satisfy a predetermined condition, the related metadata search unit 20 can identify the records as the same record. For example, assuming that, when a plurality of records have two or more common attribute relationships (i.e., a set of a common attribute name and a common attribute value), those records are identified as the same record, _:r1 and _:r2 can be identified as the same record in the above example. Note that a condition for identifying two records as the same record is not limited to the above example. For example, a list of attribute names identified as the same record may be defined in advance and a plurality of records whose attribute values associated with attribute names included in the list are the same may be defined as the same record by the related metadata search unit 20. Alternatively, the related metadata search unit 20 may estimate the same record on the basis of a search result of the metadata.

Then, the related metadata search unit 20 acquires, from the metadata database 19, an attribute relationship regarding _:r1 identified as the record that is the same as _:r2 included in the input data (Step S705). Herein, it is possible to acquire two pieces of metadata “author of _:r1 is Alice” and “due date of _:r1 is 2012/7/30” (see FIG. 6). Further, in a case where an attribute regarding an attribute value exists, the related metadata search unit 20 can also acquire metadata “type of drawing (which is C01.jpg, C01.jpg) of _:r1 is tube” by following the attribute. In this way, the related metadata search unit 20 determines, as additional attribute information, three pieces of attribute information “author of _:r2 is Alice”, “due date of _:r2 is 2012/7/30”, and “type of drawing of _:r2 (which is C01.jpg, C01.jpg) is tube”.

Thereafter, the data processing unit 23 adds an attribute to the input data 801 on the basis of the additional attribute information determined by the related metadata search unit 20 (Step S706).

FIG. 10 shows the processing (Step S706) in which the data processing unit 23 adds the attribute to the input data 801 in Example 1 of the invention.

The data processing unit 23 adds additional attribute information 1002 to the table structure attribute information 802 and changes the additional attribute information 1002 in table form, thereby producing processed data 1003. In the example of FIG. 10, three pieces of attribute information “author of _:r2 is Alice”, “due date of _:r2 is 2012/7/30”, and “type of drawing (which is C01.jpg, C01.jpg) of _:r2 is tube” are added in a table form. Herein, in a case where an attribute value associated with a certain attribute name is associated with another attribute name like the above relationship among the “drawing”, “C01.jpg”, and “type”, the plurality of attribute name expressions are connected and a new attribute name is displayed. In the example of FIG. 10, the plurality of attribute name expressions, i.e., “type” of “drawing”, are connected by a hyphen symbol and are expressed as “drawing-type”. Such the processed data 1003 shows a relation among the input data 801, the image metadata 404, and the document metadata 504.

Then, the data output unit 24 outputs the processed data 1003.

In this way, the data processing is performed.

In this example, an example of expanding the inputted table on the basis of the metadata database constructed in advance has been described. By using the synonym dictionary as the same relevance dictionary to perform association of a term in the metadata database and association of a term in the inputted table, it is possible to associate information extracted from the document data and the image data with the inputted table. Further, by expressing the metadata in the form of the RDF, it is possible to associate data of different modalities which are a table, a document, and an image on the basis of a single synonym dictionary.

Although the metadata regarding the type of the image is used in this example, a result of extraction of another kind of information can be also used. For example, as to an image such as a photograph of a face, a name of a person extracted by using a face image recognition may be used as the metadata.

### EXAMPLE 2

Hereinafter, Example 2 of the invention will be described with reference to drawings.

This example will describe an example of a data processing system for presenting information related to inputted text data on the basis of a metadata database extracted from sound data and text data. This system can be used for managing, for example, recorded telephone conversation and a reception log of operators accumulated in a call center. When text is inputted, this system displays relevant sound and a relevant reception log with the use of metadata extracted from the recorded sound and the reception log. This makes it possible to effectively search information without listing all recorded sound.

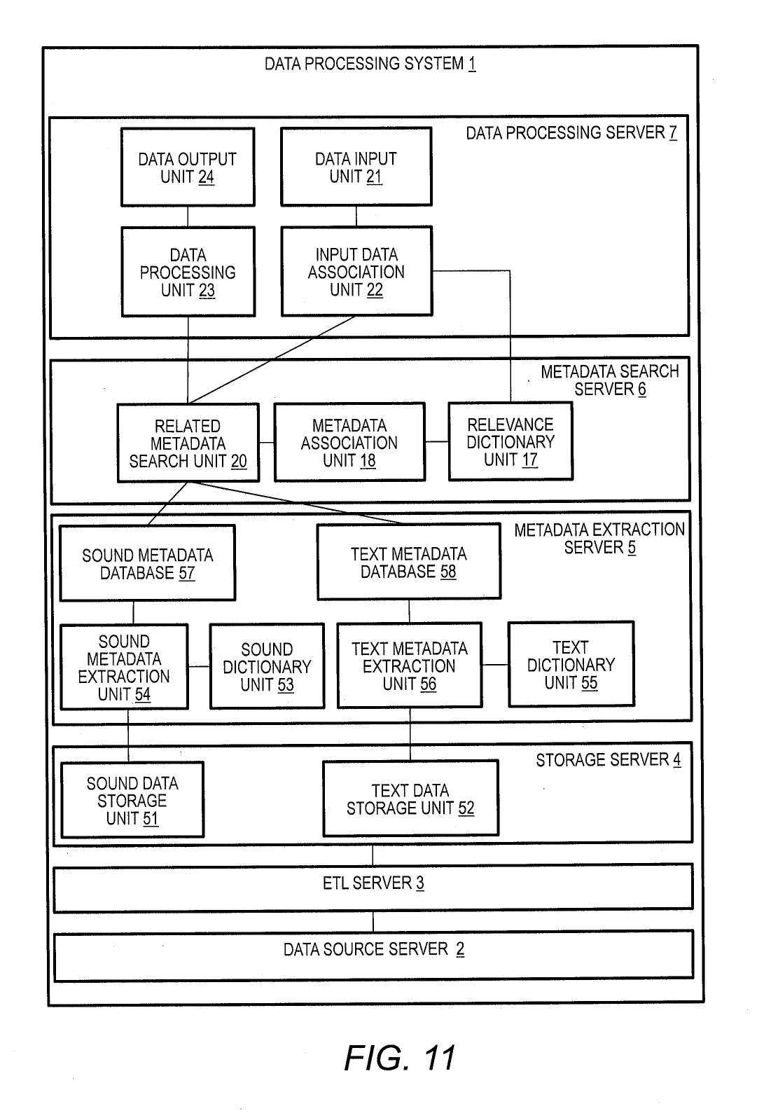

FIG. 11 is a block diagram showing a whole configuration of a data processing system in Example 2 of the invention.

In this example, the image data and the document data in Example 1 are replaced with sound data and text data, and metadata databases are separately constructed for the sound data and for the text data. Those are associated not at the time of construction of the metadata databases but at the time of search of metadata.

Units of the data processing system of Example 2 denoted by reference signs that are the same as those of Example 1 shown in FIG. 1 have the same functions, except the above differences and differences described in detail below. Therefore, description thereof is omitted.

The data processing system 1 of this example, as well as that of Example 1, includes the data source server 2, the ETL server 3, the storage server 4, the metadata extraction server 5, the metadata search server 6, and the data processing server 7.

The data source server 2 is a device for managing sound and text and includes a relational database for managing recorded sound data by linking the recorded sound data to an ID and a file server for storing a sound data file and a text file.

The ETL server 3 has a function of storing, in the storage server 4, sound data and text data stored in the data source server 2. Herein, conversion such as unification of a format of the sound data is performed.

The storage server 4 includes a sound data storage unit 51 and a text data storage unit 52 and stores, in a unified format, sound data and text data collected from a plurality of data sources.

The metadata extraction server 5 includes a sound dictionary unit 53, a sound metadata extraction unit 54, a text dictionary unit 55, a text metadata extraction unit 56, a sound metadata database 57, and a text metadata database 58 and manages metadata extracted from the data stored in the storage server 4.

The metadata search server 6 includes the relevance dictionary unit 17, the metadata association unit 18, and the related metadata search unit 20 and receives a search request to return a result of search of the sound metadata database 57 and a result of search of the text metadata database 58.

The data processing server 7 includes the data input unit 21, the input data association unit 22, the data processing unit 23, and the data output unit 24 and processes inputted data on the basis of the metadata to output the processed data.

A hardware configuration of the data processing system 1 of this example is similar to the configuration of Example 1 shown in FIG. 2. However, the disk 244 of the storage server 4 includes the sound data storage unit 51 and the text data storage unit 52 instead of including the image data storage unit 11 and the document data storage unit 12. The disk 254 of the metadata extraction server 5 includes the sound dictionary unit 53, the text dictionary unit 55, the sound metadata database 57, and the text metadata database 58 instead of including the image dictionary unit 13, the document dictionary unit 15, the relevance dictionary unit 17, and the metadata database 19. The memory 253 of the metadata extraction server 5 includes the sound metadata extraction unit 54 and the text metadata extraction unit 56 instead of including the image metadata extraction unit 14, the document metadata extraction unit 16, and the metadata association unit 18. The memory 263 of the metadata search server 6 includes not only the related metadata search unit 20 but also the metadata association unit 18, and the disk 264 includes the relevance dictionary unit 17.

Operation of the data processing system 1 configured as described above according to this example will be described. The operation of this system, as well as that of Example 1, is divided into metadata database construction processing and data processing. The metadata database construction processing is similar to the metadata database construction processing in Example 1 shown in FIG. 3 except differences described below.

The ETL server 3 acquires sound data and text data from the data source server 2 (Step S301). Then, the ETL server 3 performs necessary conversion on the sound data and the text data (Step S302). Subsequently, the ETL server 3 stores the converted sound data and the converted text data in the storage server 4 (Step S303).

Thereafter, the metadata extraction server 5 acquires the sound data and the text data from the storage server 4 (Step S304).

Then, the sound metadata extraction unit 54 extracts metadata of the sound data on the basis of the sound dictionary unit 53 (Step S305).

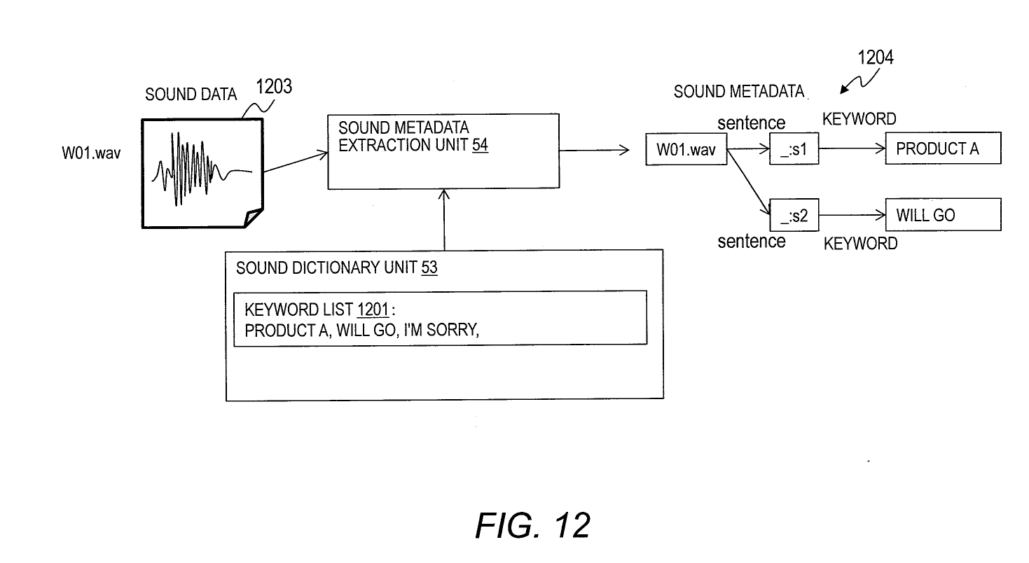

FIG. 12 shows details of the processing (Step S305) in which the sound metadata extraction unit 54 extracts the metadata of the sound data in Example 2 of the invention.

The sound dictionary unit 53 holds a keyword list 1201 that is a list of keywords detected from sound. By using a speech recognition technology based on the sound dictionary unit 53, the sound metadata extraction unit 54 divides sound data 1203 on a sentence by sentence basis and applies a keyword existing therein, thereby generating sound metadata 1204. In the example of FIG. 12, two keywords “product A” and “will go” are extracted from the sound data 1203. The sound metadata 1204 describes four relationships such as “sentence of W01.wav includes _:s1”, “sentence of W01.wav includes _:s2”, “keywords of _:s1 include “product A″”, and “keywords of _:s2 include “will go″”. Those relationships can be described with the use of the RDF in the same way as Example 1.

Similarly, in Step S305, the text metadata extraction unit 56 extracts metadata of the text data on the basis of the text dictionary unit 55.

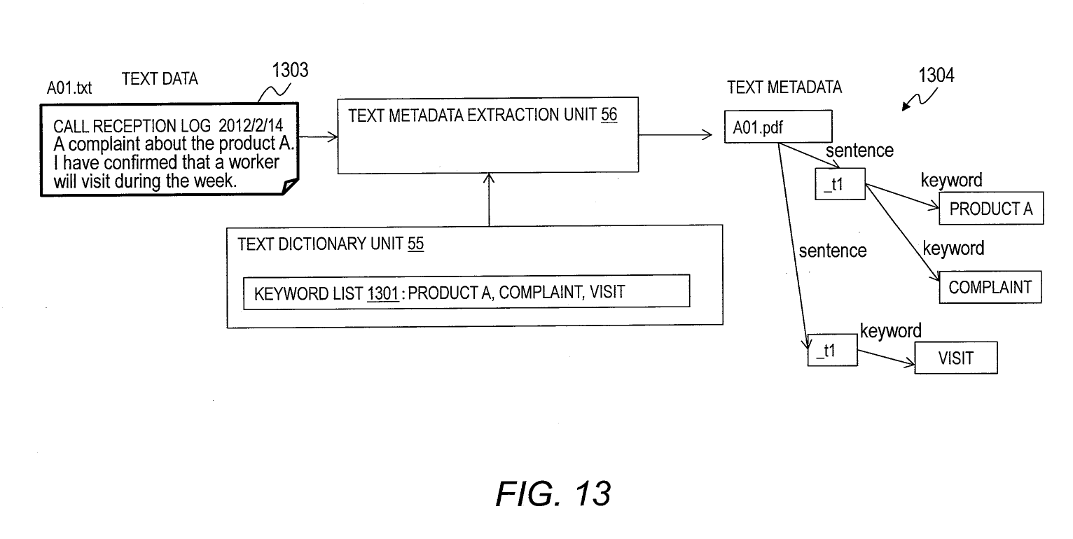

FIG. 13 shows details of the processing (Step S305) in which the text metadata extraction unit 56 extracts the metadata of the text data in Example 2 of the invention.

The text dictionary unit 55 holds a keyword list 1301 extracted from text. The text metadata extraction unit 56 analyzes the text data 1303 on the basis of the text dictionary unit 55 and a result of morphological analysis, thereby generating text metadata 1304. In the example of FIG. 13, three keywords “product A”, “complaint”, and “visit” are extracted from the text data 1303. The text metadata 1304 can be described with the use of the RDF in the same way as the sound metadata 1204.

Then, the sound metadata extraction unit 54 stores the extracted sound metadata in the sound metadata database 57 (Step S306). Similarly, in Step S306, the text metadata extraction unit 56 stores extracted text metadata in the text metadata database 58. This example is different from Example 1 in that the extracted metadata is stored as a database separated for each modality.

This example is different from Example 1 in that Step S307 for performing metadata association is not performed after the storage of the metadata (Step S306).

Operation of the data processing will be described.

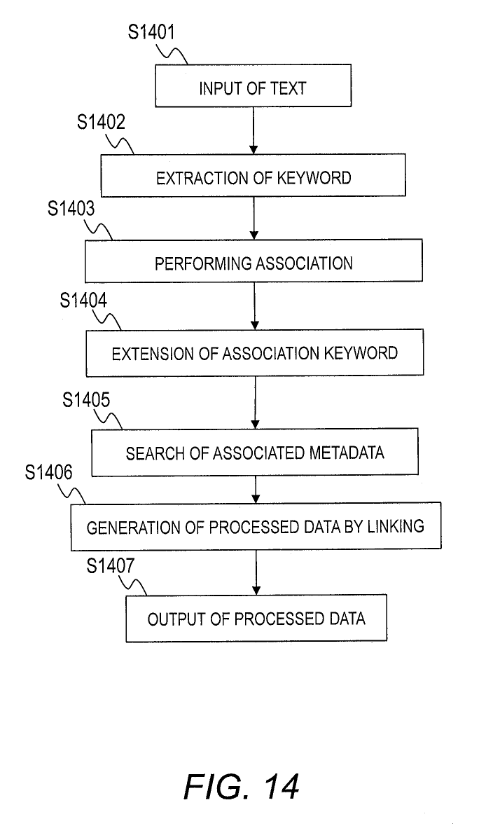

FIG. 14 is a flowchart showing the operation of the data processing in Example 2 of the invention.

The data input unit 21 receives input of text data from a user (Step S1401).

Then, the input data association unit 22 extracts a keyword from received text data (Step S1402). Herein, there will be described a case where “machine ABC visit” is inputted as text data and keywords “machine ABC” and “visit” are extracted. Alternatively, for example, in a case where text data of a natural sentence including a keyword is inputted, the input data association unit 22 may extract the keyword with the use of morphological analysis or the like.

Thereafter, the input data association unit 22 performs association on the extracted keywords with the use of the relevance dictionary unit 17 (Step S1403).

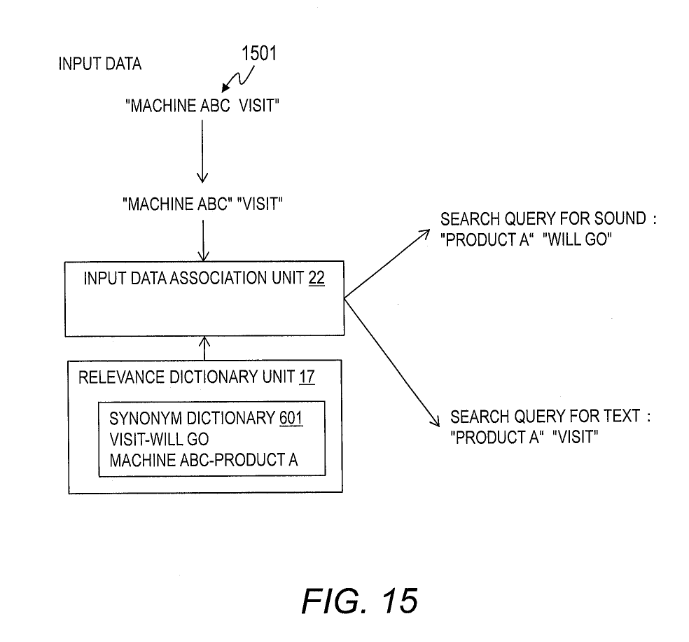

FIG. 15 shows details of the processing (Step S1403) in which the input data association unit 22 performs association on the extracted keyword in Example 2 of the invention.

In the relevance dictionary unit 17, the synonym dictionary 601 having information for mutually converting a spoken language and a written language and the like is constructed in advance. With this, “visit” and “will go” can be associated with each other. The synonym dictionary 601 shown in FIG. 15 also has information for associating “machine ABC” with “product A”. In this example, “machine ABC” and “product A” are different names of the same product (e.g., one name is identification information used in a manufacturing company and the other name is a trade name used for customers).

The input data association unit 22 can associate keywords “machine ABC” and “visit” extracted from inputted text data 1501 with “product A” and “will go”, respectively, on the basis of the synonym dictionary 601 included in the relevance dictionary unit 17.

Then, the metadata association unit 18 extends the extracted keywords on the basis of a result of the association using the relevance dictionary unit 17 (Step S1404). Specifically, the metadata association unit 18 extends the extracted keywords “machine ABC” and “visit” to keywords “product A” and “will go” for searching the sound metadata database 57 (i.e. search query for sound). Similarly, the metadata association unit 18 extends the extracted keywords “machine ABC” and “visit” to keywords “product A” and “visit” for searching the text metadata database 58 (i.e., search query for text).

Thereafter, the related metadata search unit 20 searches the sound metadata database 57 by using the keywords “product A” and “will go” and further searches the text metadata database 58 by using the keywords “product A” and “visit” (Step S1405).

Then, the data processing unit 23 associates sound metadata and text metadata searched by the related metadata search unit 20 (Step S1406).

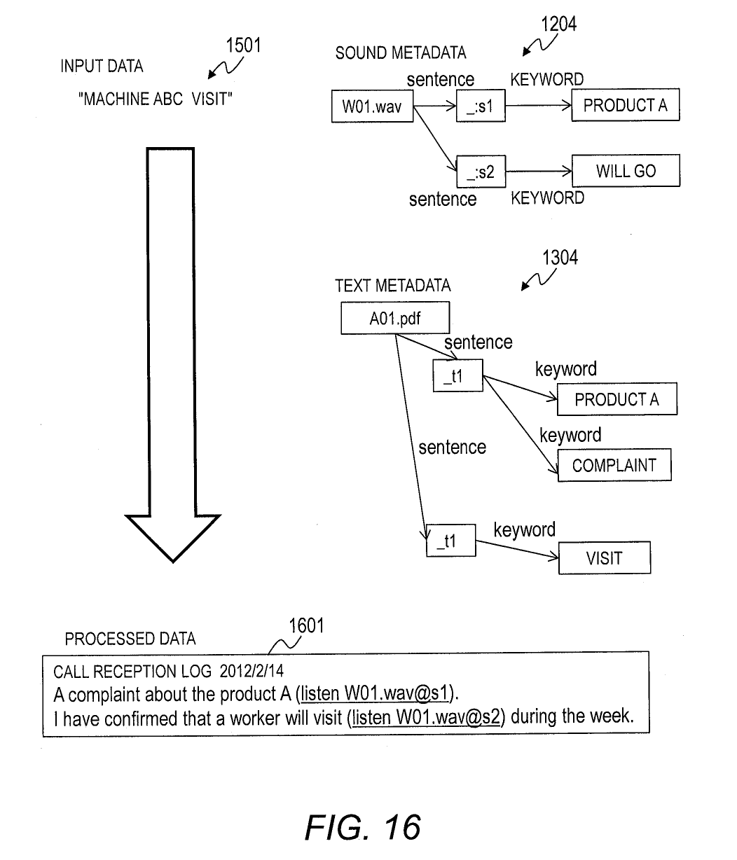

FIG. 16 shows the processing (Step S1406) in which the data processing unit 23 associates the sound metadata with the text metadata in Example 2 of the invention.

For example, in a case where the text data 1501 “machine ABC visit” is inputted in Step S1401 and the sound metadata 1204 and the text metadata 1304 are searched in Step S1405, the data processing unit 23 associates the sound data 1203 corresponding to the sound metadata 1204 with the text data 1303 corresponding to the text metadata 1304, thereby generating processed data 1601.

Specifically, for example, the data processing unit 23 generates the processed data 1601 by adding, to the keywords “product A” and “visit” included in the text data 1303, links to the keywords “product A” and “will go” (in the example of FIG. 16, “listen W01.wav@s1” and “listen W01.wav@s2”, respectively) included in the sound data 1203. In other words, the processed data 1601 is information indicating a relation between a keyword corresponding to an inputted keyword included in the text data 1303 and a part of the sound data 1203 corresponding thereto.

Then, the data output unit 24 outputs the processed data 1601 (Step S1407).

In this way, the data processing is performed.

This example is different from Example 1 in that the sound metadata database 57 and the text metadata database 58 are not associated with each other in advance. Therefore, there is a possibility that those databases have information having the same or a relevant concept, the information being information to which different expressions are given depending on modalities (e.g., expressions of a spoken language, a written language, and the like). By extending an inputted keyword on the basis of the relevance dictionary unit 17, the inputted keyword is converted into an expression in accordance with a characteristic of each modality, and therefore it is possible to perform search in accordance with the characteristic of each modality (e.g., which one of a spoken language and a written language is included). As a result, for example, it is possible to perform processing such as generation of a link of relevant sound data on text of a call reception record.

According to each embodiment of the invention described above, it is possible to process inputted data on the basis of a metadata database. By using, as the same relevance dictionary, a dictionary defining combinations of replaceable terms such as a synonym dictionary or a spoken language conversion dictionary to perform association of a term in the metadata database and association of a term in an inputted table, it is possible to associate information extracted from multimodal data such as document data, image data, and sound data with the inputted data.

Note that, in each embodiment described above, various functions of the data processing system are realized by programs executed in the CPUs of the respective servers. However, for example, a part or all thereof may be realized by hardware including an electronic component such as an integrated circuit.

The invention is not limited to the above embodiments and includes various modification examples. In the above examples, a table generation system for data mining and a system for sound log analysis of a call center are assumed. However, the invention is applicable to various systems for managing multimodal data, such as a system for managing electronic medical record data and medical image data and an editing system for broadcasting data.

Information such as a program, a table, and a file realizing functions of the above embodiment can be stored in a storage device such as a nonvolatile semiconductor memory, a hard disk drive, or an SSD (Solid State Drive) or can be stored in a computer-readable non-transitory data storage medium such as an IC card, an SD card, or a DVD.

The invention is not limited to the above embodiment and includes various modification examples. For example, the above embodiment is described in detail in order to easily understand the invention, and the invention is not necessarily limited to ones having all the configurations described above. Further, it is possible to replace a part of a configuration of a certain embodiment with a configuration of another embodiment, and it is also possible to add a configuration of another embodiment to a configuration of a certain embodiment. Furthermore, it is possible to add, delete, and replace another configuration to/from/with a part of a configuration of each embodiment.

1. A data processing system comprising:
one or more processors; and
one or more storage devices connected to the one or more processors,
wherein the data processing system
holds metadata extraction dictionary information defining a condition for extracting metadata from a plurality of kinds of data and relevance dictionary information defining a condition for associating the metadata extracted from the plurality of kinds of data,
extracts the metadata from the plurality of kinds of data on the basis of the metadata extraction dictionary information,
extracts metadata from inputted data,
associates the metadata extracted from the inputted data with the metadata extracted from the plurality of kinds of data on the basis of the relevance dictionary information, and
outputs information indicating a relation of any combination of the plurality of kinds of data, the inputted data, and the metadata extracted from the plurality of kinds of data and the inputted data on the basis of a result of the association.

2. The data processing system according to claim 1, wherein:
the plurality of kinds of data have a first kind of data and a second kind of data;
the metadata extraction dictionary information has first metadata extraction dictionary information defining a condition for extracting first metadata from the first kind of data and second metadata extraction dictionary information defining a condition for extracting the second metadata from the second kind of data;
the relevance dictionary information has information defining information that is replaceable with the metadata; and
the data processing system
extracts the first metadata and the second metadata from the first kind of data and the second kind of data, respectively, on the basis of the first metadata extraction dictionary information and the second metadata extraction dictionary information,
extracts third metadata from the inputted data,
specifies at least one of information replaceable with the first metadata, information replaceable with the second metadata, and information replaceable with the third metadata on the basis of the relevance dictionary information,
searches the first metadata or the information replaceable with the first metadata and the second metadata or the information replaceable with the second metadata by using the third metadata or the information replaceable with the third metadata, and
associates, on the basis of a result of the search, the third metadata or the information replaceable with the third metadata, the first metadata or the information replaceable with the first metadata, and the second metadata or the information replaceable with the second metadata.

3. The data processing system according to claim 2, wherein
the data processing system
specifies the information replaceable with the first metadata on the basis of the relevance dictionary information, specifies the information replaceable with the second metadata on the basis of the relevance dictionary information, and associates the first metadata with the second metadata on the basis of determination on whether or not the specified replaceable information, the first metadata, and the second metadata satisfy a predetermined condition,
specifies the information replaceable with the third metadata on the basis of the relevance dictionary information, and
in a case where the first metadata or the information replaceable with the first metadata is acquired as a search result, associates the third metadata or the information replaceable with the third metadata, the first metadata or the information replaceable with the first metadata, and the second metadata or the information replaceable with the second metadata associated with the first metadata.

4. The data processing system according to claim 2, wherein
the data processing system does not execute a step of specifying the information replaceable with the first metadata on the basis of the relevance dictionary information and a step of specifying the information replaceable with the second metadata on the basis of the relevance dictionary information and specifies the information replaceable with the third metadata on the basis of the relevance dictionary information.

5. The data processing system according to claim 2, wherein
the relevance dictionary information has information defining another term synonymous with a term included in the metadata.

6. The data processing system according to claim 2, wherein
the relevance dictionary information has information defining a term of a spoken language synonymous with a term of a written language included in the metadata and information defining a term of a written language synonymous with a term of a spoken language included in the metadata.

7. The data processing system according to claim 2, wherein
the relevance dictionary information has information defining a term of a second language synonymous with a term of a first language included in the metadata.

8. The data processing system according to claim 2, wherein:
the metadata is information having a ternary relation; and
in a case where the extracted metadata satisfies a predetermined condition regarding the ternary relation, the relevance dictionary information has a rule for generating a new ternary relation by using the satisfied ternary relation.

9. The data processing system according to claim 2, wherein:
the first kind of data is data of a first modality that is any one of text, a table structure, sound, an image, and a document, and the second kind of data is data of a second modality that is any one of text, a table structure, sound, an image, and a document but is different from the first modality; and
the relevance dictionary information has information defining information replaced between different modalities.

10. A data processing method performed by a computer system including one or more processors and one or more storage devices connected to the one or more processors,
the computer system holding metadata extraction dictionary information defining a condition for extracting metadata from a plurality of kinds of data and relevance dictionary information defining a condition for associating the metadata extracted from the plurality of kinds of data,
the data processing method, comprising:
a first step of extracting the metadata from the plurality of kinds of data on the basis of the metadata extraction dictionary information;
a second step of extracting metadata from inputted data;
a third step of associating the metadata extracted from the inputted data with the metadata extracted from the plurality of kinds of data on the basis of the relevance dictionary information; and
a fourth step of outputting information indicating a relation of any combination of the plurality of kinds of data, the inputted data, and the metadata extracted from the plurality of kinds of data and the inputted data on the basis of a result of the association.

11. The data processing method according to claim 10, wherein:
the plurality of kinds of data have a first kind of data and a second kind of data;
the metadata extraction dictionary information has first metadata extraction dictionary information defining a condition for extracting first metadata from the first kind of data and second metadata extraction dictionary information defining a condition for extracting the first metadata from the second kind of data;
the relevance dictionary information has information defining information that is replaceable with the metadata;
the first step includes a fifth step of extracting the first metadata and the second metadata from the first kind of data and the second kind of data, respectively, on the basis of the first metadata extraction dictionary information and the second metadata extraction dictionary information;
the second step includes a sixth step of extracting third metadata from the inputted data; and
the third step includes
a seventh step of specifying at least one of information replaceable with the first metadata, information replaceable with the second metadata, and information replaceable with the third metadata on the basis of the relevance dictionary information,
a eighth step of searching the first metadata or the information replaceable with the first metadata and the second metadata or the information replaceable with the second metadata by using the third metadata or the information replaceable with the third metadata, and
a ninth step of associating, on the basis of a result of the search, the third metadata or the information replaceable with the third metadata, the first metadata or the information replaceable with the first metadata, and the second metadata or the information replaceable with the second metadata.

12. The data processing method according to claim 11, wherein:
the seventh step includes
a step of specifying the information replaceable with the first metadata on the basis of the relevance dictionary information, specifying the information replaceable with the second metadata on the basis of the relevance dictionary information, and associating the first metadata with the second metadata on the basis of determination on whether or not the specified replaceable information, the first metadata, and the second metadata satisfy a predetermined condition, and
a step of specifying the information replaceable with the third metadata on the basis of the relevance dictionary information; and
the ninth step includes a step of, in a case where the first metadata or the information replaceable with the first metadata is acquired as a search result in the eighth step, associating the third metadata or the information replaceable with the third metadata, the first metadata or the information replaceable with the first metadata, and the second metadata or the information replaceable with the second metadata associated with the first metadata.

13. The data processing method according to claim 11, wherein
the seventh step
does not include a step of specifying the information replaceable with the first metadata on the basis of the relevance dictionary information and a step of specifying the information replaceable with the second metadata on the basis of the relevance dictionary information, and
includes a step of specifying the information replaceable with the third metadata on the basis of the relevance dictionary information.
